(19) United States
(12) Patent Application Publication
(10) Pub. No.: US 2022/0411660 A1
(43) Pub. Date: Dec. 29, 2022

(54) Composition for Forming Polyimide Film for Cover Window, Process for Preparing Same and Uses Thereof

(71) Applicants: SK Innovation Co., Ltd., Seoul (KR); SK ie technology Co., Ltd., Seoul (KR)

(72) Inventors: Cheol Min Yun, Daejeon (KR); Hye Jin Park, Daejeon (KR)

(21) Appl. No.: 17/836,662

(22) Filed: Jun. 9, 2022

(30) Foreign Application Priority Data
Jun. 11, 2021 (KR) 10-2021-0075793

(51) Int. Cl. C09D 179/08

(52) U.S. Cl. CPC C09D 179/08

(57) ABSTRACT

An embodiment relates to a composition for forming a polyimide film for a cover window capable of satisfying advanced performance required for a cover window, a process for preparing the same, and uses thereof. According to an embodiment, by providing a polyimide film for a cover window for use in optical applications because the polyimide film has no optical stains, implements excellent visibility, and implements excellent heat resistance and mechanical properties without deteriorating colorless and transparent optical properties. The polyimide film may be usefully used in various types of flexible display devices.

### CROSS-REFERENCE TO RELATED APPLICATION

This application claims priority to Korean Patent Application No. 10-2021-0075793 filed Jun. 11, 2021, the disclosure of which is hereby incorporated by reference in its entirety.

### BACKGROUND OF THE INVENTION

### Field of the Invention

The following disclosure relates to a composition for forming a polyimide film for a cover window, a process for preparing the same, and uses thereof.

### Description of Related Art

A polyimide (PI) film has insoluble and infusible ultra-high heat resistance, and has excellent thermal oxidation resistance, heat resistance, radiation resistance, low temperature characteristics, and chemical resistance. Accordingly, the polyimide film has been used in a wide range of technical fields, such as heat-resistant high-tech materials such as automobile materials, aviation materials, and spacecraft materials, as well as electronic materials such as an insulation coating agent, an insulating film, semiconductor, and an electrode protective film of TFT-LCD, and recently, is also attracting attention as a material to replace expensive tempered glass used as cover windows for portable electronic devices and communication devices.

A cover window for portable electronic devices and communication devices is intended to protect electronic components such as printed wiring boards and lead frames of semiconductor integrated circuits, and needs to have a certain level or higher of insulation. In addition, as portable electronic devices and communication devices become thinner, slimmer and flexible, flexibility as well as mechanical properties such as high hardness and high rigidity are required. In addition, in general, as a coating layer is multilayered on a substrate to provide various physical properties, diffuse reflection of light is induced in the cover window and optical staining may deteriorate visibility. Accordingly, high display quality and optical properties such as no mura phenomenon are also required.

### SUMMARY OF THE INVENTION

An embodiment is directed to providing a composition for forming a polyimide film for a cover window capable of satisfying advanced performance required for a cover window, and a process for preparing the same.

In detail, another embodiment is directed to providing a composition for forming a polyimide film for a cover window for providing the polyimide film for a cover window capable of implementing an anti-reflection effect in a wide viewing angle and remarkably reducing a mura phenomenon because the polyimide film has a low retardation in a thickness direction in a visible ray region, and a process for preparing the same.

Still another embodiment is directed to providing a polyimide film for a cover window for use in optical applications of a display device because the polyimide film has no optical stains, implements excellent optical properties, such as visibility, and implements excellent heat resistance and mechanical properties without deteriorating colorless and transparent optical properties.

Still yet another embodiment is directed to providing a multilayer structure including a polyimide film.

Still yet another embodiment is directed to providing a cover window for a display device including the polyimide film.

Still further yet another embodiment is directed to providing a flexible display device including the polyimide film or the cover window.

In one general aspect, a composition for forming a polyimide film for a cover window may include: a polyamic acid or polyimide comprising a structural unit derived from a dianhydride and a structural unit derived from a diamine; and a mixed solvent of an amide-based solvent and a hydrocarbon-based solvent, and the hydrocarbon solvent is included in 5 to 65 wt % based on a total weight of the mixed solvent. In the composition for forming a polyimide film for a cover window according to the embodiment, a structural unit derived from the dianhydride comprises a structural unit derived from a compound represented by Chemical Formula 1 below, a structural unit derived from a compound represented by Chemical Formula 2 below, and a structural unit derived from the diamine comprises a structural unit derived from a compound represented by Chemical Formula 3 below.

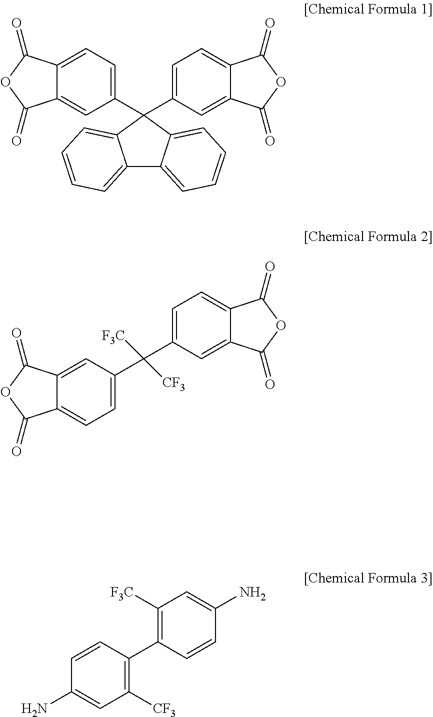

The amide-based solvent may comprise dimethylpropionamide.

The hydrocarbon-based solvent may be a cyclic hydrocarbon-based solvent.

The cyclic hydrocarbon-based solvent may comprise toluene, benzene, cyclohexane, or a combination thereof.

The amide-based solvent and the hydrocarbon-based solvent may be included in a weight ratio of 75:25 to 40:60.

A solid content may be included in 10 to 40 wt % based on the total weight of the composition for forming a polyimide film.

The structural unit derived from the compound represented by the Chemical Formula 1 above may be included in an amount of 70 to 95 mol % based on 100 mol % of the structural unit derived from the diamine.

According to another general aspect, a process for preparing a polyimide film for a cover window may include: i) preparing a polyamic acid solution by reacting a compound represented by Chemical Formula 1 below and a compound represented by Chemical Formula 2 below with a compound represented by Chemical Formula 3 below in an amide-based solvent; ii) adjusting crystallinity of the polyamic acid by additionally adding a hydrocarbon-based solvent to the polyamic acid solution; and iii) applying the composition for forming a polyimide film for a cover window obtained in step ii) to a substrate and curing the composition, in which the hydrocarbon-based solvent in step ii) is added in an amount of 5 to 65 wt % based on a total weight of the amide-based solvent and the hydrocarbon-based solvent.

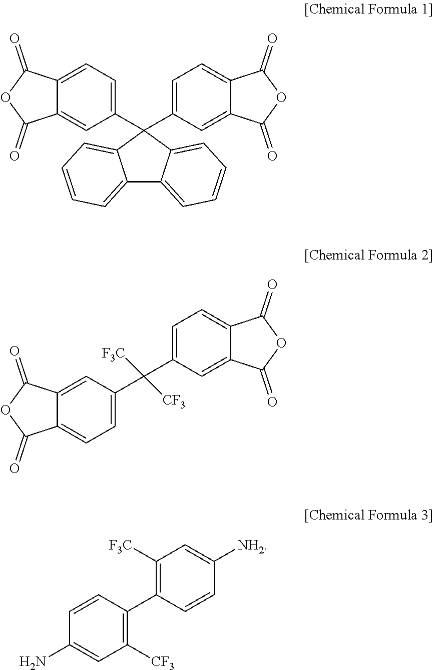 [SMILES: O=C1OC(=O)c2cc(C3(c4ccc5c(c4)C(=O)OC5=O)c4ccccc4-c4ccccc43)ccc21 ; O=C1OC(=O)c2cc(C(c3ccc4c(c3)C(=O)OC4=O)(C(F)(F)F)C(F)(F)F)ccc21 ; Nc1ccc(-c2ccc(N)cc2C(F)(F)F)c(C(F)(F)F)c1]

The curing of step iii) may be performed by heating at 80 to 300° C.

The process may further include, after the applying of step iii), leaving at room temperature.

According to still another embodiment, a polyimide film for a cover window may be prepared from the composition for forming a polyimide film for a cover window.

A thickness may be 30 to 150 μm, an absolute value of retardation Rth in a thickness direction at a wavelength of 550 nm may be 600 nm or less, and a yellow index (YI) according to ASTM E313 may be 3.5 or less.

A thickness may be 40 to 80 μm, an absolute value of retardation Rth in a thickness direction at a wavelength of 550 nm may be 100 to 450 nm or less, and a yellow index (YI) according to ASTM E313 may be 1.0 to 2.5 or less.

A modulus according to ASTM E111 may be 4 GPa or more, and a breaking elongation may be 10% or more.

According to still another embodiment, a multilayer structure may include the polyimide film formed on one surface of a substrate.

The multilayer structure may further include a coating layer formed on the polyimide film.

The coating layer may be a hard coating layer, an antistatic layer, an anti-fingerprint layer, an antifouling layer, an anti-scratch layer, a low refractive layer, an antireflection layer, an impact absorption layer, or a combination thereof.

According to still yet another embodiment, a cover window for a display device may include the polyimide film.

According to still further another embodiment, a flexible display device may include the cover window for a display device.

### DESCRIPTION OF THE INVENTION

The present disclosure relates to a composition for forming a polyimide film for a cover window and a polyimide film for a cover window formed using the same. According to an embodiment, it is possible to provide a polyimide film for a cover window capable of implementing excellent optical properties and excellent mechanical properties without deteriorating colorless and transparent performance by inhibiting an interaction between polyamic acid and a mixed solvent to remarkably reduce a packing density between molecules during curing. In addition, a polyimide film for a cover window according to an embodiment may be applied to a cover window of a flexible display because it is flexible and has excellent bending properties.

A polyimide film for a cover window according to an embodiment effectively controls an intermolecular interaction, which is a disadvantage of the polyimide film, thereby exhibiting excellent mechanical properties such as modulus and breaking elongation as well as optical properties while having excellent adhesion. Accordingly, by effectively suppressing a mura, in particular, a rainbow mura by retardation which causes a problem of visibility when used as a cover window of a display panel, it is possible to increase reliability of a display panel including the same.

Hereinafter, an embodiment of the present disclosure will be described in detail so that a person of ordinary skill in the art to which the present disclosure pertains can easily implement the present disclosure. However, the present disclosure may be implemented in various different forms and is not limited to embodiments described herein. In addition, embodiments are not intended to limit the scope of protection limited by the claims

In this case, technical terms and scientific terms used in the present specification have the general meaning understood by those skilled in the art to which the present disclosure pertains unless otherwise defined, and a description for the known function and configuration unnecessarily obscuring the gist of the present disclosure will be omitted in the following description.

Throughout the present specification, when a part “includes” a certain component, it may mean that it may further other components, rather than excluding other components, unless otherwise stated.

When an element such as a layer, a film, a thin film, a region, and a plate is “on” or “over” another component in the specification, it can be directly on the other element or intervening elements may be present therebetween, unless otherwise defined.

Hereinafter, unless otherwise defined herein, the term “combination thereof” may mean mixing or copolymerization of constituents.

Hereinafter, unless otherwise defined in the present specification, “A and/or B” may mean an aspect including A and B at the same time, and may mean an aspect selected from A and B.

Hereinafter, unless otherwise specified in the present specification, “derived” means that at least one of functional groups of a compound is modified, and specifically includes a form in which a reactive group and/or a leaving group of the compound are modified or left according to the reaction. In addition, if structures derived from different compounds are the same as each other, structures derived from one compound may be derived from another compound and have the same structure.

Unless otherwise defined herein, “polymer” refers to a molecule having a relatively high molecular weight, and its structure may include multiple repeats of units derived from molecules of a low molecular weight. In one aspect, the polymer is an alternating copolymer, a block copolymer, a random copolymer, a branched copolymer, a crosslinked copolymer, or a copolymer (e.g., a copolymer comprising more than one type of monomer) comprising both. In another aspect, the polymer may be a homopolymer (e.g., a copolymer comprising one monomer).

Hereinafter, unless otherwise defined herein, “polyamic acid” may refer to a polymer comprising a structural unit having an amic acid moiety, and “polyimide” may refer to a polymer comprising a structural unit having an imide moiety.

Hereinafter, unless otherwise defined herein, the polyimide film may be a film comprising polyimide, and specifically, the polyimide film may be a high-heat resistance film that is prepared by preparing polyamic acid by solution polymerization of a dianhydride compound and a diamine compound or a diisocyanate compound, and then imidizing the polyamic acid by ring closure dehydration at a high temperature.

Hereinafter, unless otherwise defined herein, the term “mura phenomenon” may be interpreted to encompass all distortions caused by light that may be caused at a specific angle. For example, in a display device including a polyimide film, distortion due to light, such as a blackout phenomenon in which a screen appears black, a hot spot phenomenon, or a rainbow phenomenon having iridescent stains, may be mentioned.

Many attempts have been made to combine or change monomers having various structures in order to increase optical and mechanical properties while imparting functionality to the conventional polyimide film. However, mechanical properties and optical properties are in a trade-off relationship with each other, and such an attempt has no choice but to obtain extremely general results of reduced functionality or deteriorated optical properties even if the mechanical properties of the polyimide are improved. Accordingly, there is a need for a new attempt capable of simultaneously imparting excellent mechanical properties, functionality, and optical properties.

The composition (hereinafter, also referred to as composition for forming a polyimide film) for forming a polyimide film for a cover window according to an embodiment may not be used as a polymerization solvent of polyamic acid (hereinafter, referred to as a polyimide precursor) and/or polyimide, and may provide the polyimide film capable of simultaneously improving the optical physical properties and mechanical physical properties by applying a non-polar solvent that has no affinity with polyimide. Specifically, the composition for forming a polyimide film according to the embodiment may have an improved yellow index while having adhesiveness equal to or higher than that of an existing optical adhesive film, and provide a polyimide film having remarkably reduced distortion by light. Accordingly, the polyimide film prepared from the composition for forming a polyimide film according to the embodiment may be applied to a new substrate material or a cover window material applicable to a foldable or flexible display device, and the polyimide film has excellent visibility, so a user's eye fatigue may be minimized.

The composition for forming a polyimide film according to the embodiment may comprise polyamic acid and/or polyimide; a polar solvent; and a non-polar solvent. The polar solvent may be a hydrophilic solvent, and may have affinity with, for example, polyamic acid and/or polyimide, and for example, may be an amide-based solvent. In addition, the non-polar solvent may have little affinity with polyamic acid and/or polyimide, and may be, for example, a hydrocarbon-based solvent.

Although not limited to a particular theory, by using a mixed solvent of an amide-based solvent and a hydrocarbon-based solvent, an intermolecular interaction between polymers and/or an interaction between the polymer and the solvent may be effectively inhibited, and during curing, a packing density between molecules is remarkably lowered, so the desired excellent optical and mechanical properties may be improved simultaneously.

Therefore, the composition for forming a polyimide film according to the embodiment may exhibit the intermolecular behavior and interaction different than the mixed solution in the existing polymerization step of the polyamic acid. For example, when the hydrocarbon-based solvent is included in the step of polymerizing the polyamic acid, as the hydrocarbon-based solvent acts as a factor to hinder the polymerization. Therefore, a high molecular weight polyamic acid may not be obtained. On the other hand, in the composition for forming a polyimide film according to the embodiment, after obtaining the polyamic acid and/or polyimide having a sufficient high molecular weight, the polyamic acid and/or polyimide and the hydrocarbon-based solvent are mixed, such that the mixture of the polyamic acid and/or polyimide and the hydrocarbon-based solvent may act as a catalyst to weaken the intermolecular interaction between the polymers and/or the strong interaction between the polymer and the solvent, and the desired optical properties may be obtained during subsequent curing.

The composition for forming a polyimide film for a cover window according to the embodiment may comprise: a polyamic acid and/or polyimide comprising a structural unit derived from a dianhydride and a structural unit derived from a diamine; and a mixed solvent of an amide-based solvent and a hydrocarbon-based solvent, in which the hydrocarbon-based solvent may be included in 5 to 65 wt % based on the total weight of the mixed solvent. The structural unit derived from the dianhydride may comprise a structural unit derived from a compound represented by Chemical Formula 1 below and a structural unit derived from a compound represented by Chemical Formula 2 below, and may comprise a structural unit derived from a compound represented by Chemical Formula 3 below. Accordingly, it is possible to provide the polyimide film for a cover window having improved optical properties by inhibiting packing density and making the polyimide film amorphous.

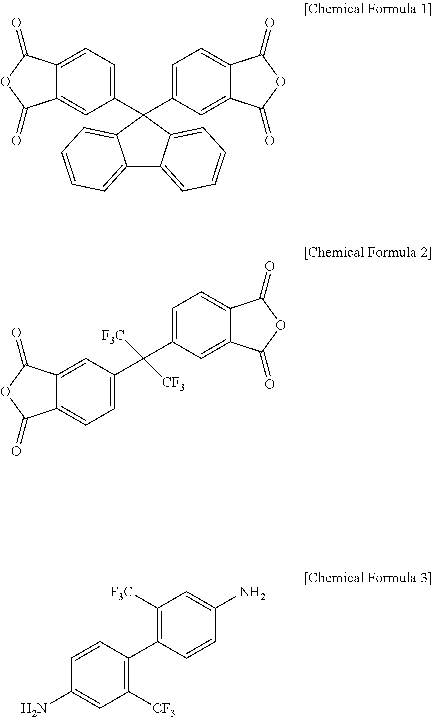

As described above, in the composition for forming a polyimide film for a cover window according to the embodiment, as the mixed solvent of the amide-based solvent and the hydrocarbon-based solvent is used, specifically, after the polyamic acid and/or polyimide having a sufficient high molecular weight is obtained, the crystallinity of the polyamic acid and/or polyimide in the solution is adjusted by adding the hydrocarbon-based solvent, thereby simultaneously improving the excellent optical properties and mechanical properties. Here, by sequentially using the amide-based solvent and the hydrocarbon-based solvent, it is possible to adjust the interaction between the polyamic acid, which is the polyimide precursor, and/or the polyimide and the solvent to a more appropriate range. Here, the adjustment may mean inhibition.

The amide-based solvent means a compound including an amide moiety. The amide-based solvent may be aromatic or aliphatic, but may be, for example, aliphatic. In addition, for example, the amide-based solvent may be a cyclic compound or a chain compound, and specifically, may have 2 to 15 carbon atoms, for example, 3 to 10 carbon atoms.

The amide-based solvent may comprise an N,N-dialkylamide moiety, and the dialkyl groups are each independently present and fused with each other to form a ring, or at least one alkyl group of the dialkyl groups may be fused with other substituents in molecules to form a ring, and for example, at least one alkyl group of the dialkyl group may be fused with an alkyl group connected to carbonyl carbon of the amide moiety to form a ring. Here, the ring may be tetragonal to heptagonal rings, and for example, may be pentagonal to heptagonal rings, and for example, a pentagonal or hexagonal ring. The alkyl group may be, for example, a C1 to C10 alkyl group, for example, a C1 to C8 alkyl group, for example, methyl or ethyl, and the like.

Specifically, the amide-based solvent is not limited as long as it is generally used for polymerization of polyamic acid, but may be, for example, dimethylpropionamide, diethylpropionamide, dimethylacetylamide, diethylacetamide, dimethylformamide, methylpyrrolidone, ethylpyrrolidone, octylpyrrolidone, or a combination thereof, and specifically may comprise dimethylpropionamide.

The hydrocarbon-based solvent may be a non-polar solvent as described above.

The hydrocarbon solvent may be a compound consisting of carbon and hydrogen. For example, the hydrocarbon-based solvent may be aromatic or aliphatic, and for example, may be a cyclic compound or a chain compound, but specifically, may be a cyclic compound. Here, when the hydrocarbon solvent is a cyclic compound, the hydrocarbon solvent may include a single ring or a polycyclic ring, and the polycyclic ring may be a condensed ring or a non-condensed ring, but specifically may be a single ring.

The hydrocarbon-based solvent may have 3 to 15 carbon atoms, for example, 6 to 15 carbon atoms, for example, 6 to 12 carbon atoms.

The hydrocarbon-based solvent may be a substituted or unsubstituted C3 to C15 cycloalkane, a substituted or unsubstituted C6 to C15 aromatic compound, or a combination thereof. Here, the cycloalkane may comprise cyclobutane, cyclopentane, cyclohexane, cycloheptane, cyclooctane, or a combination thereof, and the aromatic compound may comprise benzene, naphthalene, or a combination thereof.

The hydrocarbon-based solvent may be a cycloalkane substituted or unsubstituted with at least one C1 to C5 alkyl group, an aromatic compound substituted or unsubstituted with at least one C1 to C5 alkyl group, or a combination thereof, in which the cycloalkane and aromatic compounds each are as described above.

The C1 to C5 alkyl group may be, for example, a C1 to C3 alkyl group, for example, a C1 or C2 alkyl group, and more specifically, a methyl group, but is not limited thereto.

In addition, the hydrocarbon-based solvent may further comprise oxygen, if necessary. For example, when the hydrocarbon-based solvent comprises oxygen, the hydrocarbon-based solvent may comprise a ketone group or a hydroxyl group, for example, cyclopentanone, cresol, or a combination thereof.

Specifically, the hydrocarbon-based solvent may comprise benzene, toluene, cyclohexane, cyclopentanone, cresol, or a combination thereof, but is not limited thereto.

More specifically, the composition for forming a polyimide film for a cover window according to an embodiment may comprise a mixed solvent that comprises an amide-based solvent comprising dimethylpropionamide and a hydrocarbon-based solvent selected from toluene, benzene, cyclohexane, and the like.

The composition for forming a polyimide film for a cover window according to an embodiment comprises polyamic acid and/or polyimide comprising structural units derived from diamine and dianhydride exemplified above.

The solid content of the composition for forming a polyimide film for a cover window according to the embodiment may be 10 to 40 wt % or less, or 10 to 35 wt % or less, or 10 to 20 wt % based on the total weight of the composition for forming a polyimide film. Here, the solid content may be the polyamic acid and/or polyimide.

The composition for forming a polyimide film for a cover window according to the embodiment may comprise 5 to 65 wt % of the hydrocarbon-based solvent. Here, wt % is based on the total weight of the solvent, and the total weight of the solvent as a reference may mean the sum of the total weight of the amide-based solvent and the hydrocarbon-based solvent.

In addition, by comprising the hydrocarbon-based solvent in an amount of 15 wt % or more or 25 wt % or more, it is possible to implement a more improved yellow index and haze. In addition, since the hydrocarbon-based solvent is included in an amount of 25 to 60 wt %, at the same time, the adhesion to a substrate such as glass may be more remarkably improved. Specifically, the mixed solvent may comprise the amide-based solvent and the hydrocarbon-based solvent in a weight ratio of 75:25 to 40:60.

The polyamic acid and/or polyimide may have a weight average molecular weight (Mw) of 10,000 to 80,000 g/mol, 10,000 to 70,000 g/mol, or 10,000 to 60,000 g/mol.

In addition, the composition for forming a polyimide film for a cover window according to the embodiment may further comprise a structural unit derived from one or more dianhydrides selected from BPDA (3,3′,4,4′-biphenyltetracarboxylic dianhydride), BTDA (3,3′,4,4′-benzophenonetetracarboxylic dianhydride), ODPA (4,4′-oxydiphthalic anhydride), BPADA (4,4′-(4,4′-isopropylbiphenoxy)biphthalic anhydride), DSDA (3,3′,4,4′-diphenylsulfonetetracarboxylic dianhydride), TMHQ (p-phenylene bistrimelic monoester anhydride), ESDA (2,2′-bis(4-hydroxyphenyl)propanedibenzoate-3,3′,4,4′-tetracarboxylicdianhydride), NTDA (naphthalene tetracarboxylic dianhydride), TMEG (ethylene glycol bis(anhydro-trimellitate)), or the like, but is not limited thereto.

In addition, the composition for forming a polyimide film for a cover window according to the embodiment may further comprise a structural unit derived from one or more diamine selected from PDA (p-phenylenediamine), m-PDA (m-phenylenediamine), 4,4′-ODA (4,4′-oxydianiline), 3,4′-ODA(3,4′-oxydianiline), BAPP (2,2-bis(4-[4-aminophenoxy]-phenyl)propane), TPE-Q (1,4-bis(4)-aminophenoxy)benzene), TPE-R (1,3-bis(4-aminophenoxy)benzene), BAPB (4,4′-bis(4-aminophenoxy)biphenyl), BAPS (2,2-bis(4-[4-aminophenoxy]phenyl)sulfone), m-BAPS (2,2-bis(4-[3-aminophenoxy]phenyl)sulfone), HAB (3,3′-dihydroxy-4,4′-diaminobiphenyl), TB (3,3-dimethylbenzidine), m-TB (2,2-dimethylbenzidine), 6FAPB (1,4-bis(4-amino-2-trifluoromethylphenoxy)benzene), TFMB (2,2-bistrifluoromethylbenzidine), 6FAPB (1,4-bis(4-amino-2-trifluoromethylphenoxy)benzene), 6FODA (2,2′-bis(trifluoromethyl)-4,4′-diaminodiphenylether), APB(1,3-bis (3-aminophenoxy)benzene), 1,4-ND(1,4-naphthalenediamine), 1,5-ND(1,5-naphthalenediamine), DABA(4,4′-diaminobenzanilide), 6-amino-2-(4-aminophenyl)benzoxazole, 5-amino-2-(4-aminophenyl)benzoxazole, or the like.

In addition, the aromatic diamine may further comprise a fluorine-based aromatic diamine. Here, as a specific aspect of the fluorine-based aromatic diamine, 6FAPB (1,4-bis(4-amino-2-trifluoromethylphenoxy)benzene), 6FODA (2,2′-bis(trifluoromethyl)-4,4′-diaminodiphenyl ether), or a combination thereof may further be included in TFMB (2,2-bistrifluoromethylbenzidine). Accordingly, it is possible to provide a film having higher total light transmittance and lower haze.

The composition for forming a polyimide film according to the embodiment may comprise the polyamic acid and/or polyimide further comprising the structural units derived from the diamine and dianhydride described above.

When the thin film is prepared by a solution process, for example, a coating process, the composition for forming a polyimide film according to the embodiment of the present disclosure may remarkably lower the viscosity of the composition, even if the composition includes a high content of solid, so the composition may be applied to a solution process, specifically, a thin film coating process due to its high solid content and low viscosity. In general, a high solid content of 10 wt % or more (based on the total weight of the composition) is required for the thin film coating, but in the case of the polyimide, the higher the concentration of the solid content, the higher the viscosity tends to be. Here, when the flow of the polymer in the thin film coating process is not good, bubble removal and mura may occur in the coating. However, when the embodiment is applied, the defects during the thin film coating process may be effectively prevented, so more improved optical properties may be realized. In addition, as described above, when dissolved in the amide-based solvent alone, it is difficult to increase the concentration of the solid content due to the high viscosity, thereby reducing the process efficiency. According to the embodiment, the composition for forming a polyimide film may be used as a composition for a polyimide film having a high solid content without causing such a problem, and thus may be commercially advantageous.

Furthermore, compared to a polyimide film containing a polyimide polymer having a rigid structure, the cured film formed to a thickness of 30 to 150 μm by curing the composition for forming a polyimide film for a cover window, that is, the polyimide film for a cover window may further improve the distortion by light. For example, in the polyimide film for a cover window according to the embodiment, the structural unit derived from the dianhydride may not comprise a rigid structural unit, and may not comprise, for example, a structural unit derived from a dianhydride in which two anhydride groups are fused to one ring. The ring may be a single ring or a condensed ring, and may be an aromatic ring, an aliphatic ring, or a combination thereof. Specifically, the structural unit derived from the dianhydride may not comprise a structural unit derived from pyromellitic dianhydride (PMDA), a structural unit derived from cyclobutane-1,2,3,4-tetracarboxylic dianhydride (CBDA), or a combination thereof.

Accordingly, the polyimide film for a cover window according to the embodiment may implement a low retardation in the thickness direction while being transparent even at a thickness of 30 μm or more, and further improve visibility, thereby further reducing eye fatigue when the cover window including the polyimide film for a cover window is used. In addition, even if the polyimide film for a cover window has a thickness of 30 μm or more, since the polyimide film for a cover window may further improve excellent optical characteristics, the polyimide film may further improve mechanical strength such as modulus, and further improve dynamic bending properties, and thus, may be more suitable for application as a cover window of a flexible display device that repeatedly performs a folding and unfolding operation.

In the composition for forming a polyimide film for a cover window according to the embodiment, the structural unit derived from the compound represented by the Chemical Formula 1 above may be included in an amount of 70 to 95 mol % based on 100 mol % of the structural unit derived from the diamine. Here, the structural unit derived from the diamine may be, specifically, a total mole % of the structural unit derived from the compound represented by the Chemical Formula 3 above. By comprising the structural unit derived from the compound represented by the Chemical Formula 1 above as described above, even when the thickness of the polyimide film for a cover window is 30 μm or more, it is possible to have better mechanical properties such as modulus and breaking elongation as well as providing more transparent and low retardation in a thickness direction. Accordingly, the optical and mechanical properties equivalent to or superior to those of tempered glass may be implemented.

Specifically, the structural unit derived from the compound represented by Chemical Formula 1 above may have better optical properties and more excellent modulus in the above-described range based on 100 mol % of the structural unit derived from the diamine as the content of the structural unit derived from the compound represented by the Chemical Formula 1 above increases. Meanwhile, when the content of the structural unit derived from the compound represented by the Chemical Formula 1 above is reduced in the above-described range, the breaking elongation may be more excellent.

Hereinafter, the use of the polyimide film for a cover window according to the embodiment will be described.

A first aspect according to an embodiment may be a multilayer structure including the polyimide film for a cover window of the present disclosure. Here, the multilayer structure may include the polyimide film for a cover window of the present disclosure and the polyimide film comprising monomers of different compositions as two or more coating layers.

In addition, a second aspect according to an embodiment may be a cover window for a display device including the polyimide film for a cover window of the present disclosure and a coating layer formed on the film.

In addition, a third aspect according to an embodiment may be a flexible display device including the polyimide film for a cover window of the present disclosure.

In the polyimide film for a cover window according to the embodiment, a thickness may be 30 to 150 μm, an absolute value of retardation Rth in a thickness direction at a wavelength of 550 nm may be 600 nm or less, and a yellow index (YI) according to ASTM E313 may be 3.5 or less. The retardation value in the thickness direction may be measured at normal temperature before heating the film, and the normal temperature may be a temperature in a state in which temperature control is not artificially performed. For example, the room temperature may be 20° C. to 40° C., 20° C. to 30° C., or 23° C. to 26° C.

When the polyimide film for a cover window according to the embodiment has a thickness of 30 to 150 μm, the absolute value of the retardation Rth in the thickness direction at a wavelength of 550 nm may be 550 nm or less or 100 to 500 nm. For example, when the polyimide film for a cover window has a thickness of 40 to 80 μm, the absolute value of the retardation Rth in the thickness direction at a wavelength of 550 nm may be 100 to 450 nm, 200 to 400 nm, or 210 to 380 nm.

In addition, when the polyimide film for a cover window according to the embodiment has a thickness of 30 to 150 μm, a yellow index may be 3.5 or less, 3.0 or less, or 1 to 3.0. For example, when the polyimide film for a cover window has a thickness of 40 to 80 μm, the yellow index may be 1.0 to 2.5 or 1.5 to 2.3.

Specifically, when the polyimide film for a cover window according to the embodiment has a thickness of 30 to 150 μm, the polyimide film for a cover window may simultaneously satisfy the retardation Rth in the thickness direction at a wavelength of 550 nm and the yellow index. Further, when the polyimide film for a cover window has a thickness of 40 to 80 μm, the polyimide film for a cover window may simultaneously satisfy the retardation Rth in the thickness direction at a wavelength of 550 nm and the yellow index.

In addition, when the polyimide film for a cover window according to the embodiment has a thickness of 30 to 150 μm, the polyimide film may be a polyimide film satisfying that (a) the modulus according to ASTM E111 is 4 GPa or more, and (b) the breaking elongation is 10% or more, and more specifically, may be a polyimide film satisfying the mechanical properties as well as the retardation Rth in the thickness direction at a wavelength of 550 nm and the yellow index as described above.

The polyimide film for a cover window according to the embodiment may have, specifically, a modulus of 4 GPa or more, 4.1 GPa or more, or 4.1 to 6 GPa according to ASTM E111. In addition, the polyimide film for a cover window may have a breaking elongation of 10% or more, 12% or more, 14% or more, or 15 to 40%, and specifically, may simultaneously satisfy the modulus and breaking elongation described above. Accordingly, it is possible to provide sufficient mechanical properties and durability to be applied to the cover window.

The first aspect, the second aspect, or the third aspect according to the embodiment includes the polyimide film for a cover window capable of remarkably reducing the distortion by light and satisfying the mechanical properties such as the modulus and breaking elongation, and may further include a coating layer having functionality, if necessary.

The coating layer is formed on at least one other surface of the polyimide film or substrate for a cover window according to the embodiment, and non-limiting examples thereof may include a hard coating layer, an antistatic layer, an anti-fingerprint layer, an antifouling layer, an anti-scratch layer, a low refractive layer, an antireflection layer, an impact absorption layer, and the like, and may include at least one or two or more functional coating layers. In this case, the thickness of the coating layer may be 1 to 500 μm, 2 to 450 μm, or 2 to 200 μm.

With such excellent optical and mechanical properties, the polyimide film for a cover window exhibits sufficient phase difference even at various angles including the cover window of the display device, so it is expected that the range of applications of the polyimide film will be expanded in various industrial fields that may secure a wide viewing angle.

As the polyimide film for a cover window according to the embodiment satisfies all of the retardation in the thickness direction, the yellow index, the modulus, and the breaking elongation in the above-described ranges, it is possible to prevent image distortion due to light and provide further improved visibility. In addition, more uniform mechanical properties (modulus, etc.) and optical properties (retardation in the thickness direction, etc.) may be exhibited as a whole in a central portion and an edge portion of the film, and the film loss may be further reduced. In addition, since the polyimide film for a cover window is flexible and has excellent bending characteristics, the film is not deformed and/or damaged even if a predetermined deformation occurs repeatedly, and may be more easily restored to its original shape.

The cover window including the polyimide film for a cover window according to the embodiment may have more excellent visibility, and prevent the occurrence of folding marks and microcracks to provide better durability and long-term lifespan of the flexible display device.

The polyimide film for a cover window according to an embodiment may be made of a polyimide resin comprising the structural unit derived from the diamine and dianhydride exemplified above, and specifically, the polyimide resin may be a weight average molecular weight (Mw) of 10,000 to 80,000 g/mol, mol, 10,000 to 70,000 g/mol, or 10,000 to 60,000 g/mol, but is not limited thereto.

As described above, the polyimide film for a cover window according to the embodiment has excellent optical properties and mechanical properties, and thus, may exhibit a sufficient retardation even at various angles including the cover window of the display device, so the polyimide film may be applied to various industrial fields that require a wide viewing angle.

For example, the display device is not particularly limited as long as it is a field requiring excellent optical properties, and a display panel suitable for this may be selected and provided. Specifically, the polyimide film for a cover window may be applied to a flexible display device. Non-limiting examples thereof include, but are not limited to, various image display devices such as a liquid crystal display device, an electroluminescence display device, a plasma display device, and a field emission display device.

In addition, the display device including the cover window polyimide film according to the embodiment described above has excellent display quality as well as remarkably reduces the distortion by light, and in particular, may remarkably improve rainbow phenomenon in which iridescent stains occur, and minimize user's eye fatigue due to excellent visibility. In particular, as a screen size of the display device increases, the case of viewing the screen from the side increases. When the polyimide film for a cover window according to the embodiment of the present disclosure is applied to the display device, the visibility is excellent even from the side, so the polyimide film may be usefully applied to the large display device.

Hereinafter, a method of manufacturing a polyimide film for a cover window according to an embodiment will be described.

In an embodiment, when the cured film formed to a thickness of 30 to 150 μm, the film capable of simultaneously satisfying physical properties in which the absolute value of the retardation Rth in the thickness direction at a wavelength of 550 nm is 600 nm or less and the yellow index (YI) according to ASTM E313 is 3.5 or less is manufactured, the manufacturing method is not limited, and the method to be described below is only specifically exemplified as an example, and is not limited to the method to be described below as long as the film satisfying the above physical properties is manufactured.

Specifically, according to the method for manufacturing a polyimide film for a cover window according to the embodiment, the polyimide film may be manufactured by applying the composition for forming a polyimide for a cover window described above to a substrate such as glass, and then heat curing or drying and thermally curing the composition. More specifically, the method includes i) preparing a polyamic acid and/or polyimide solution by reacting dianhydride and diamine in an amide-based solvent; ii) adjusting the crystallinity of the polyamic acid and/or polyimide by additionally adding a hydrocarbon-based solvent to the polyamic acid and/or polyimide solution; and iii) applying the composition for forming a polyimide film for a cover window obtained in step ii) to a substrate and curing the composition, in which the hydrocarbon-based solvent in step ii) may be additionally added so as to be 5 to 65 wt % based on the total weight of the amide-based solvent and the hydrocarbon-based solvent. Here, the dianhydride and the diamine may be as described above, respectively, and for example, the dianhydride may comprise the compound represented by the Chemical Formula 1 above and the compound represented by the Chemical Formula 2 above, and the diamine may comprise the compound represented by the Chemical Formula 3 above.

Specifically, in the method for manufacturing a polyimide film for a cover window according to an embodiment, the polyamic acid and/or polyimide solution may comprise 70 to 95 mole % of the compound represented by the Chemical Formula 1 above based on 100 mole % of the diamine. In addition, the compound represented by the Chemical Formula 2 above may be included in an amount of 5 to 30 mol % based on 100 mol % of the diamine. Here, the diamine may be a compound represented by the Chemical Formula 3 above.

In addition, the dianhydride and the diamine may be included in a molar ratio of 1:0.9 to 1:1.1, in which the dianhydride may comprise the compound represented by the Chemical Formula 1 above and the compound represented by the Chemical Formula 2 above. For example, the number of moles of the dianhydride may be the sum of the number of moles of the compound represented by the Chemical Formula 1 above and the compound represented by the Chemical Formula 2 above.

In addition, the polyamic acid and/or polyimide solution satisfying the above mole % may have a solid content of 10 to 40 wt % based on the total weight. Here, the solid content may be the polyamic acid and/or polyimide, and the remaining amount may be an organic solvent.

In the method of manufacturing a polyimide film for a cover window according to the embodiment, the solid content of the polyamic acid and/or polyimide solution may be 40 wt % or less, 35 wt % or less, or 10 to 20 wt %. More specifically, according to the present disclosure, even when the solid content of the polyamic acid and/or polyimide solution is 10 to 20 wt %, it may have a low viscosity to provide advantages in process. In general, the mechanical properties such as the absolute value of the retardation Rth in the thickness direction and the modulus have a trade-off relationship with each other, so it is difficult to simultaneously improve these physical properties. However, according to the embodiment of the present disclosure, these physical properties may be simultaneously improved even at a thickness of 30 μm or more.

The step of adjusting the crystallinity of the polyamic acid in step ii) may be performed by additionally adding the hydrocarbon-based solvent to the polyamic acid solution, and may be performed by additionally adding the hydrocarbon-based solvent and a solvent different from the hydrocarbon-based solvent. Here, the other solvent may be an amide-based solvent, in which the amide-based solvent may be the same as or different from the amide-based solvent added in step i). By adding the hydrocarbon-based solvent, the intermolecular interaction between the polyamic acid and/or the polyimide and/or the interaction between the polymer and the solvent may be effectively inhibited, and the packing density between molecules during curing may be remarkably reduced. Accordingly, according to the embodiment of the present disclosure, it is possible to provide the polyimide film for a cover window that remarkably improves the yellow index and the retardation Rth in the thickness direction at a wavelength of 550 nm, and at the same time, satisfies a thickness of 30 μm or more implementing mechanical properties reaching a level similar to that of tempered glass. In particular, it is possible to provide the polyimide film for a cover window in which the mura phenomenon according to the viewing angle is remarkably reduced despite satisfying a thickness of 30 μm or more.

The curing step may be performed through thermal curing. Here, in addition to the thermal curing, a chemical curing method, an infrared curing method, a batch curing method, a continuous curing method, etc., may be replaced by various known methods or replaced by a different curing method.

The thermal curing may be performed at 80 to 300° C., 100 to 280° C., or 150 to 250° C.

The thermal curing may be performed at 80 to 100° C. for 1 minute to 2 hours, at 100 to 200° C. for 1 minute to 2 hours, or at more than 200 to 300° C. for 1 minute to 2 hours. Stepwise thermal curing may be performed under two or more temperature conditions selected from these. In addition, the thermal curing may be performed in a separate vacuum oven, an oven filled with an inert gas, or the like, but is not necessarily limited thereto.

In addition, before the thermal curing, if necessary, a drying step may be additionally performed. The drying step may be performed at 30 to 70° C., 35 to 65° C., or 40 to 55° C., but is not limited thereto.

In addition, in the method of manufacturing a polyimide film for a cover window according to an embodiment, the applying for forming the polyimide film may be used without limitation as long as it is generally used in the relevant field. Non-limiting examples thereof may include knife coating, dip coating, roll coating, slot die coating, lip die coating, and slide coating, and curtain coating, and the like, and the like. In this regard, it goes without saying that the same type or different types can be sequentially applied one or more times.

The substrate may be used without limitation as long as it is conventionally used in the field, and non-limiting examples thereof may comprise glass; stainless; or plastic films such as polyethylene terephthalate, polyethylene naphthalate, polypropylene, polyethylene, cellulose triacetate, cellulose diacetate, poly(meth)acrylic acid alkyl ester, a poly(meth)acrylic acid ester copolymer, polyvinyl chloride, polyvinyl alcohol, polycarbonate, polystyrene, cellophane, a polyvinylidene chloride copolymer, polyamide, polyimide, vinyl chloride/vinyl acetate copolymer, polytetrafluoroethylene, and polytrifluoroethylene.

In the process for preparing a polyimide film for a cover window according to an embodiment, if necessary, the method may further include applying the composition for forming a polyimide film for a cover window to a substrate and then leaving the composition at room temperature. Through the leaving step, the optical properties of the film surface may be more stably maintained. Although not limited to a particular theory, in the conventional composition for forming a polyimide film for a cover window, when the leaving step is performed before the curing, the solvent absorbs moisture in the air, the moisture diffuses inside, and collides with polyamic acid and/or polyimide, and thus, cloudiness may occur from the surface of the film, and agglomeration may occur, resulting in coating non-uniformity. On the other hand, the composition for forming a polyimide film for a cover window according to the embodiment of the present disclosure does not have the cloudiness or agglomeration phenomenon even if the composition is left in air for a long time, and thus, it is possible to realize the advantage of securing a film having improved optical properties.

The leaving step may be performed at room temperature and/or high humidity conditions. Here, the room temperature may be 40° C. or less, for example, 30° C. or less, for example, 25° C. or less, more specifically 15 to 25° C., for example, 20 to 25° C. In addition, the high humidity may be a relative humidity of, for example, 50% or more, for example, 60% or more, for example, 70% or more, for example, 80% or more.

The leaving step may be performed for 1 minute to 3 hours, for example, 10 minutes to 2 hours, for example, 20 minutes to 1 hour.

In the process for preparing a polyimide film for a cover window according to the embodiment, one or more additives selected from a flame retardant, an adhesion enhancer, inorganic particles, antioxidant, UV inhibitor, plasticizer, and the like are mixed in the polyamic acid solution, thereby preparing the polyimide film for a cover window.

Hereinafter, an embodiment will be given for a detailed description of an embodiment, but the present disclosure is not limited to Examples below.

In experiment below, the physical properties were measured as follows.

### Retardation Rth

Retardation Rth was measured using AxoScan (OPMF, Axometrics Inc.). The retardation Rth in the thickness direction was measured for a wavelength of 400 nm to 800 nm, and the absolute value was expressed based on a wavelength of 550 nm. The unit is nm.

### Yellow index (YI)

A yellow index was measured using a spectrophotometer (Nippon Denshoku, COH-5500) based on ASTM E313 standard.

### Modulus and Breaking Elongation

According to ASTM E111, a specimen having a thickness of 50 μm, a length of 50 mm, and a width of 10 mm was measured using Instron's UTM 3365 under the conditions of pulling at 50 mm/min at 25° C. The unit of the modulus is Gpa, and the unit of the breaking elongation is %.

### Example 1

### Preparation of Composition for forming Polyimide Film for Cover Window (TFMB(0.99)/BPAF(0.85)/6FDA(0.15), Unit: Molar Ratio)

After filling 305.6 g of N,N-dimethylpropionamide (DMPA) in a reactor through which a nitrogen stream flows, 24.4 g of 2,2-bistrifluoromethylbenzidine (TFMB) were dissolved while maintaining a temperature of a reactor at 25° C. Here, 30 g of 9,9-bis (3,4-dicarboxyphenyl) fluorene dianhydride (BPAF) and 5.13 g of 2,2′-bis-(3,4-dicarboxylphenyl) hexafluoropropane dianhydride (6FDA) were added at 25° C., and stirred while being dissolved for 24 hours.

Thereafter, 131.0 g of toluene was added at 25° C., and stirred for 18 hours. Then, polyimide film-forming composition 1 for a cover window was prepared by adding the DPMA and/or toluene so that the solid content becomes 12 wt % based on the total weight of the composition, and the content of toluene in the composition becomes 30 wt % based on the total weight of the DMPA and toluene (that is, DMPA:toluene=70 wt %:30 wt %).

### Manufacture of Polyimide Film for Cover Window

The composition 1 for forming a polyimide film for a cover window 1 obtained above was applied to one surface of a glass surface (1.0 T) with #20 mayer bar, cured by heating at 80° C. for 30 minutes under a nitrogen stream, and then at 350° C. for 15 minutes, and peeled off from the glass substrate, thereby obtaining the polyimide film for a cover window of Example 1 having a thickness of 50 μm.

### Example 2

### Preparation of Composition for forming Polyimide Film for Cover Window (TFMB(0.99)/BPAF(0.7)/6FDA(0.3))

After filling 245 g of dimethylpropionamide (N,N-dimethylpropionamide (DMPA)) in a reactor through which a nitrogen stream flows, 29.6 g of 2,2-bistrifluoromethylbenzidine (TFMB) were dissolved while maintaining a temperature of a reactor at 25° C. Here, 30 g of 9,9-bis (3,4-dicarboxyphenyl) fluorene dianhydride (BPAF) and 12.5 g of 2,2′-bis-(3,4-dicarboxylphenyl) hexafluoropropane dianhydride (6FDA) were added at 25° C., and stirred while being dissolved for 24 hours.

Thereafter, 105.6 g of toluene was added at 25° C., and stirred for 18 hours. Then, polyimide film-forming composition 2 for a cover window was prepared by adding the DPMA and/or toluene so that the solid content becomes 12 wt % based on the total weight of the composition, and the content of toluene in the composition becomes 30 wt % based on the total weight of the DMPA and toluene (that is, DMPA:toluene=70 wt %:30 wt %).

### Manufacture of Polyimide Film for Cover Window

Using the obtained composition 2 for forming a polyimide film for a cover window, a polyimide film for a cover window of Example 2 having a thickness of 50 μm was obtained in the same manner as in Example 1.

### Example 3

### Preparation of Composition for forming Polyimide Film for Cover Window (TFMB(0.99)/BPAF(0.95)/6FDA(0.05))

After filling 181 g of dimethylpropionamide (N,N-dimethylpropionamide (DMPA)) in a reactor through which a nitrogen stream flows, 21.8 g of 2,2-bistrifluoromethylbenzidine (TFMB) were dissolved while maintaining a temperature of a reactor at 25° C. Here, 30 g of 9,9-bis (3,4-dicarboxyphenyl) fluorene dianhydride (BPAF) and 1.53 g of 2,2′-bis-(3,4-dicarboxylphenyl) hexafluoropropane dianhydride (6FDA) were added at 25° C., and stirred while being dissolved for 24 hours.

Thereafter, 78.2 g of toluene was added at 25° C., and stirred for 18 hours. Then, polyimide film-forming composition 3 for a cover window was prepared by adding the DPMA and/or toluene so that the solid content becomes 12 wt % based on the total weight of the composition, and the content of toluene in the composition becomes 30 wt % based on the total weight of the DMPA and toluene (that is, DMPA:toluene=70 wt %:30 wt %).

### Manufacture of Polyimide Film for Cover Window

Using the obtained composition 3 for forming a polyimide film for a cover window, a polyimide film for a cover window of Example 3 having a thickness of 50 μm was obtained in the same manner as in Example 1.

### Example 4

### Preparation of Composition for forming Polyimide Film for Cover Window (TFMB(0.99)/BPAF(0.65)/6FDA(0.35))

After filling 220 g of dimethylpropionamide (N,N-dimethylpropionamide (DMPA)) in a reactor through which a nitrogen stream flows, 26.6 g of 2,2-bistrifluoromethylbenzidine (TFMB) were dissolved while maintaining a temperature of a reactor at 25° C. Here, 25 g of 9,9-bis (3,4-dicarboxyphenyl) fluorene dianhydride (BPAF) and 13 g of 2,2′-bis-(3,4-dicarboxylphenyl) hexafluoropropane dianhydride (6FDA) were added at 25° C., and stirred while being dissolved for 24 hours.

Thereafter, 94.7 g of toluene was added at 25° C., and stirred for 18 hours. Then, polyimide film-forming composition 4 for a cover window was prepared by adding the DPMA and/or toluene so that the solid content becomes 12 wt % based on the total weight of the composition, and the content of toluene in the composition becomes 30 wt % based on the total weight of the DMPA and toluene (that is, DMPA:toluene=70 wt %:30 wt %).

### Manufacture of Polyimide Film for Cover Window

Using the obtained composition 4 for forming a polyimide film for a cover window, a polyimide film for a cover window of Example 4 having a thickness of 50 μm was obtained in the same manner as in Example 1.

### Examples 5 to 10

### Preparation of Composition for forming Polyimide Film for Cover Window (TFMB(0.99)/BPAF(0.7)/6FDA(0.3))

Each composition 5 to 10 for forming a polyimide film for a cover window was prepared in the same manner as in Example 2 but prepared by adjusting the content (T content) of toluene based on the total weight of DMPA and toluene as shown in Table 1 below.

### Manufacture of Polyimide Film for Cover Window

Using the obtained compositions for forming a polyimide film for a cover window, respectively, a polyimide film for a cover window of Examples 5 to 10 having a thickness of 50 μm was obtained in the same manner as in Example 1.

### Comparative Example 1

### Preparation of Composition for forming Polyimide Film for Cover Window (TFMB(0.99)/BPAF(1))

After filling 370 g of DMPA in a reactor through which a nitrogen stream flows, 20.74 g of TFMB was dissolved while the temperature of the reactor was maintained at 25° C. Here, 30 g of BPAF was added at a temperature of 25° C. and stirred while being dissolved for 24 hours. Composition a for forming a polyimide film for a cover window was prepared by adding a DMPA solvent so that the solid content of the composition prepared from the above reaction was 12 wt %.

### Manufacture of Polyimide Film for Cover Window

Using the obtained composition a for forming a polyimide film for a cover window, the polyimide film for a cover window of Comparative Example 1 having a thickness of 50 μm was obtained in the same manner as in Example 1.

### Comparative Example 2

Preparation of Composition for forming Polyimide Film for Cover Window (TFMB(0.99)/6FDA(1))

After filling 260 g of DMPA in a reactor through which a nitrogen stream flows, 21.4 g of TFMB was dissolved while the temperature of the reactor was maintained at 25° C. Here, 30 g of 6FDA was added at a temperature of 25° C. and stirred while being dissolved for 24 hours. Composition b for forming a polyimide film for a cover window was prepared by adding a DMPA solvent so that the solid content of the composition prepared from the above reaction was 12 wt %.

### Manufacture of Polyimide Film for Cover Window

Using the obtained composition b for forming a polyimide film for a cover window, the polyimide film for a cover window of Comparative Example 2 having a thickness of 50 μm was obtained in the same manner as in Example 1.

### Comparative Example 3

### Manufacture of Polyimide Film for Cover Window (TFMB(1)/PMDA(0.25)/BPAF(0.75))

After filling 290 g of DMPA in a reactor through which a nitrogen stream flows, 17.62 g (55 mmol) of TFMB was dissolved while maintaining the temperature of the reactor at 25° C. Here, 18.9 g (41 mmol) of BPAF and 3 g (14 mmol) of pyromellitic dianhydride (PMDA) were added at 25° C. and stirred while being dissolved for 24 hours. Composition c for forming a polyimide film for a cover window was prepared by adding a DMPA solvent so that the solid content of the composition prepared from the above reaction was 12 wt %.

### Polyimide Film for Cover Window

Using the obtained composition c for forming a polyimide film for a cover window, the polyimide film for a cover window of Comparative Example 3 having a thickness of 50 μm was obtained in the same manner as in Example 1.

### Evaluation: Optical and Mechanical Properties

The yellow index (YI), the retardation, the modulus, and the breaking elongation of the polyimide based films for a cover window of Examples 1 to 10 and Comparative Examples 1 to 3 were measured and shown in Tables 2 and 3 below.

TABLE 1

| | T | | |
|---|---|---|---|
| | content | dianhydride | diamine |
| | (wt %) | (molar ratio) | (molar ratio) |
| Example 1 | 30 | BPAF(0.85)/6FDA(0.15) | TFMB(0.99) |
| Example 2 | 30 | BPAF(0.7)/6FDA(0.3) | TFMB(0.99) |
| Example 3 | 30 | BPAF(0.95)/6FDA(0.05) | TFMB(0.99) |
| Example 4 | 30 | BPAF(0.65)/6FDA(0.35) | TFMB(0.99) |
| Example 5 | 20 | BPAF(0.7)/6FDA(0.3) | TFMB(0.99) |
| Example 6 | 25 | BPAF(0.7)/6FDA(0.3) | TFMB(0.99) |
| Example 7 | 40 | BPAF(0.7)/6FDA(0.3) | TFMB(0.99) |
| Example 8 | 50 | BPAF(0.7)/6FDA(0.3) | TFMB(0.99) |
| Example 9 | 60 | BPAF(0.7)/6FDA(0.3) | TFMB(0.99) |
| Example 10 | 65 | BPAF(0.7)/6FDA(0.3) | TFMB(0.99) |
| Comparative | — | BPAF(1) | TFMB(0.99) |
| Example 1 | | | |
| Comparative | — | 6FDA(1) | TFMB(0.99) |
| Example 2 | | | |
| Comparative | — | PMDA(0.25)/BPAF(0.75) | TFMB(0.99) |
| Example 3 | | | |

TABLE 2

| | | | | | | breaking |
|---|---|---|---|---|---|---|
| | | thickness | | Rth | modulus | elongation |
| | | (μm) | YI | (@500 nm) | (GPa) | (%) |
| Example | 1 | 50 | 2.0 | 290 | 4.6 | 15 |
| | 2 | 50 | 2.3 | 380 | 4.3 | 18 |
| | 3 | 50 | 2.1 | 265 | 4.7 | 10 |
| | 4 | 50 | 2.4 | 395 | 3.9 | 20 |
| | 5 | 50 | 2.5 | 390 | 3.8 | 20 |
| | 6 | 50 | 2.2 | 373 | 4.2 | 20 |
| | 7 | 50 | 2.2 | 376 | 4.2 | 20 |
| | 8 | 50 | 2.2 | 364 | 4.2 | 20 |
| | 9 | 50 | 2.2 | 360 | 4.2 | 20 |
| | 10 | 50 | 2.2 | 360 | 3.8 | 20 |
| Comparative | 1 | 50 | 2.1 | 240 | 4.7 | 5 |
| | 2 | 50 | 3.1 | 530 | 3.5 | 25 |
| | 3 | 50 | ≥45 | 1500 | 7.5 | 15 |

Referring to Table 2, it could be seen that, in the polyimide based films for a cover window according to Examples 1 to 10, even at a thickness of 50 μm or more, which is sufficient for use as a cover window, the absolute value of the retardation in the thickness direction at a wavelength of 550 nm is low, and the yellow index (YI) according to ASTM E313 is excellent. Therefore, the polyimide film for a cover window according to Examples 1 to 10 has the low retardation Rth in the thickness direction in a wide visible ray region, and thus, has the high breaking elongation with the high strength characteristics while remarkably improving the reflective appearance, so the polyimide film may be suitable to be applied as a cover window of a foldable display device, a flexible display device, or the like.

On the other hand, it could be seen that the polyimide film according to Comparative Example 1 has a low breaking elongation of 5% or less despite a thickness of 50 μm or more, and the polyimide film according to Comparative Example 2 has a modulus of 3.5 or less, so the polyimide film has low mechanical properties and is not inappropriate for the cover window. In addition, it could be seen that the polyimide film for a cover window of Comparative Example 3 is a colored film with poor visibility since the absolute value of the retardation in the thickness direction at a wavelength of 550 nm is very high as much as 1500 nm, and the yellow index is very high as much as 45 or more, so the polyimide film is not suitable for application as a cover window.

Hereinabove, although one embodiment has been described by limited examples, these are only provided to help a more general understanding of the present disclosure. Therefore, the present disclosure is not limited to the embodiments. Various modifications and changes may be made by those skilled in the art to which the present disclosure pertains from this description.

Therefore, the spirit of the present disclosure should not be limited to these embodiments, but the claims and all of modifications equal or equivalent to the claims are intended to fall within the scope and spirit of the present disclosure.

1. A composition for forming a polyimide film for a cover window, comprising:
a polyamic acid or polyimide comprising a structural unit derived from a dianhydride and a structural unit derived from a diamine; and
a mixed solvent of an amide-based solvent and a hydrocarbon-based solvent, wherein the hydrocarbon-based solvent is included in an amount of 5 to 65 wt % based on a total weight of the mixed solvent, and
a structural unit derived from the dianhydride comprises a structural unit derived from a compound represented by Chemical Formula 1 below and a structural unit derived from a compound represented by Chemical Formula 2 below, and a structural unit derived from the diamine includes a structural unit derived from a compound represented by Chemical Formula 3 below:

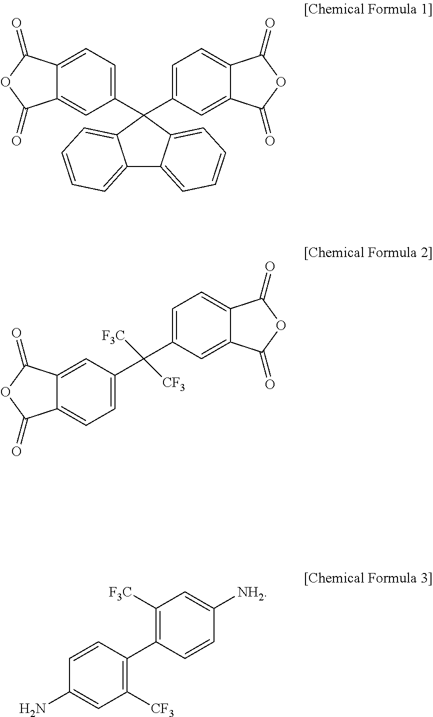

2. The composition of claim 1, wherein the amide-based solvent comprises dimethylpropionamide.

3. The composition of claim 1, wherein the hydrocarbon-based solvent is a cyclic hydrocarbon-based solvent.

4. The composition of claim 3, wherein the cyclic hydrocarbon-based solvent comprises toluene, benzene, cyclohexane, or a combination thereof.

5. The composition of claim 1, wherein the amide-based solvent and the hydrocarbon-based solvent is included in a weight ratio of 75:25 to 40:60.

6. The composition of claim 1, wherein a solid content is included in a weight ratio of 10 to 40 wt % based on a total weight of the composition for forming a polyimide film for a cover window.

7. The composition of claim 1, wherein the structural unit derived from the compound represented by the Chemical Formula 1 above is included in an amount of 70 to 95 mol % based on 100 mol % of the structural unit derived from the diamine.

8. A process for preparing a polyimide film for a cover window, comprising the steps of:
i) preparing a polyamic acid solution by reacting a compound represented by Chemical Formula 1 below and a compound represented by Chemical Formula 2 below with a compound represented by Chemical Formula 3 below in an amide-based solvent;
ii) adjusting crystallinity of the polyamic acid by additionally adding a hydrocarbon-based solvent to the polyamic acid solution; and
iii) applying the composition for forming a polyimide film for a cover window obtained in step ii) to a substrate and curing the composition,
wherein the hydrocarbon-based solvent in step ii) is added in an amount of 5 to 65 wt % based on a total weight of the amide-based solvent and the hydrocarbon-based solvent:

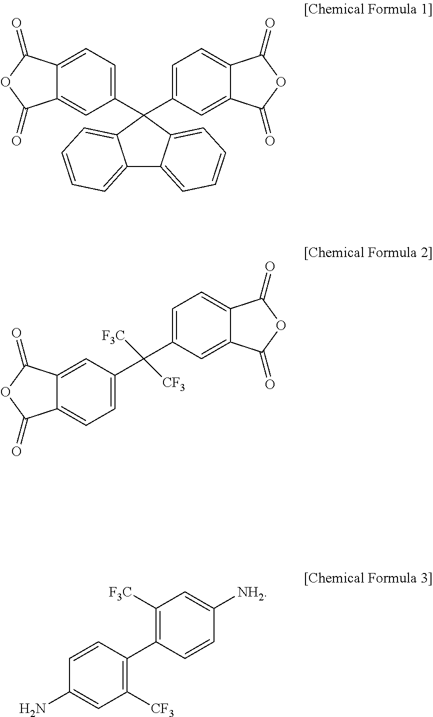 [SMILES: O=C1OC(=O)c2cc(C3(c4ccc5c(c4)C(=O)OC5=O)c4ccccc4-c4ccccc43)ccc21 ; O=C1OC(=O)c2cc(C(c3ccc4c(c3)C(=O)OC4=O)(C(F)(F)F)C(F)(F)F)ccc21 ; Nc1ccc(-c2ccc(N)cc2C(F)(F)F)c(C(F)(F)F)c1]

9. The process of claim 8, wherein the curing of step iii) is performed by heating at 80 to 300° C.

10. The process of claim 8, further comprising after the applying of step iii), leaving at room temperature.

11. A polyimide film for a cover window prepared from the composition for forming a polyimide film for a cover window according to claim 1.

12. The polyimide film of claim 11, wherein a thickness is 30 to 150 μm, an absolute value of retardation Rth in a thickness direction at a wavelength of 550 nm is 600 nm or less, and a yellow index (YI) according to ASTM E313 is 3.5 or less.

13. The polyimide film of claim 11, wherein a thickness is 40 to 80 μm, an absolute value of retardation Rth in a thickness direction at a wavelength of 550 nm is 100 to 450 nm or less, and a yellow index (YI) according to ASTM E313 is 1.0 to 2.5 or less.

14. The polyimide film of claim 11, wherein a modulus according to ASTM E111 is 4 GPa or more, and a breaking elongation is 10% or more.

15. A multilayer structure comprising the polyimide film according to claim 11 formed on one surface of a substrate.

16. The multilayer structure of claim 15, further comprising a coating layer formed on the polyimide film.

17. The multilayer structure of claim 16, wherein the coating layer is
a hard coating layer, an antistatic layer, an anti-fingerprint layer, an antifouling layer, an anti-scratch layer, a low refractive layer, an antireflection layer, an impact absorption layer, or a combination thereof.

18. A cover window for a display device comprising the polyimide film according to claim 11.

19. A flexible display device comprising the cover window for a display device according to claim 18.
